(19) United States
(12) Patent Application Publication
(10) Pub. No.: US 2013/0268798 A1
(43) Pub. Date: Oct. 10, 2013

(54) Microprocessor System Having Fault-Tolerant Architecture

(71) Applicants: Kai Schade, Munster (DE); Peter Zimmerschitt-Halbig, Gross-Zimmern (DE); Andreas Heise, Erzhausen (DE)

(72) Inventors: Kai Schade, Munster (DE); Peter Zimmerschitt-Halbig, Gross-Zimmern (DE); Andreas Heise, Erzhausen (DE)

(73) Assignee: Continental Teve AG & Co. oHG, Frankfurt (DE)

(21) Appl. No.: 13/988,176

(22) PCT Filed: Nov. 18, 2011
(86) PCT No.: PCT/EP2011/070414

§ 371 Date: Jun. 26, 2013

(30) Foreign Application Priority Data
Nov. 19, 2010 (DE) 10 2010 044 191.0
Nov. 17, 2011 (DE) 10 2011 086 530.6

(51) Int. Cl. G06F 11/00

(52) U.S. Cl. CPC G06F 11/004
USPC 714/3; 714/38.1

(57) ABSTRACT

The invention relates to a microprocessor system for executing software modules, at least some of which are security critical, within the scope of controlling functions or tasks assigned to the software modules, comprising an intrinsically safe microprocessor module having at least two microprocessor cores. At least one further intrinsically safe microprocessor module having at least two microprocessor cores is provided. At least two microprocessor modules are connected via a bus system, at least two software modules are provided which execute functions, at least some of which overlap, the software modules having at least partially overlapping functions are distributed on a microprocessor module or n at least two microprocessor modules, and means for comparing or arbitrating events generated with the software modules for the identical functions are provided in order to detect software or hardware faults.

### CROSS-REFERENCE TO RELATED APPLICATION

This application claims priority to German Patent Application Nos. 10 2010 044 191.0, filed Nov. 19, 2010; 10 2011 086 530.6, filed Nov. 17, 2011; and PCT/EP2011/070414, filed Nov. 18, 2011.

### FIELD OF THE INVENTION

The invention relates to a microprocessor system for executing at least partially safety-critical software modules as part of the control and/or regulation of functions or tasks associated with the software modules.

### BACKGROUND OF THE INVENTION

The prior art discloses inherently safe microcontrollers and microprocessor systems for safety-relevant motor vehicle controllers.

In this case, the term “inherently safe” is considered to be the capability of an electronic system that remains in the safe state or immediately changes to another safe state upon the occurrence of particular faults, or to shut down when a fault has occurred. A subset of the property is the fault silent property of a component in a system which communicates with other components and, upon recognition of a fault within the component, transmits no further information and itself no longer performs any further actions.

By way of example, known inherently safe microcontrollers comprise two microprocessor cores which execute the same program in clock sync (lockstep mode, LSM) and shut down upon the occurrence of a fault. Other known microcontrollers comprise three or more cores and a majority unit which, in the event of a fault, decides which of the processors has performed correct calculations and which then transmits the task to be performed to the correctly calculating processor (fault tolerant principle), i.e. it is the property or capability of a system to perform its specified function or task even with a limited number of faulty subsystems or components.

In addition, microcontrollers which are made up of two fault silent systems having two cores each to form a fault tolerant system are also already known.

In addition, hardware structures are known in which two separate microcontroller units (MCUs) are arranged so as to be physically closely adjacent, with the result that they are able to interchange data with one another quickly.

Today's safety-relevant systems in a motor vehicle, such as an ESP (electronic stability program) control system, which require malfunctions in the electronics to be safety detected, usually use redundancies for fault recognition for the relevant controllers in such systems, that is to say inherently safe microprocessor modules or microprocessor platforms having two microprocessor cores (dual core architecture), for example, which are locked in lockstep mode. Such microprocessor modules can be used to redundantly calculate ESP functions and to check them for a match. If a discrepancy in the results occurs, the ESP system is shut down.

Defects in hardware components are recognized by means of special protection, such as by means of a checksum calculation prior to bus transfer or by means of checksum memories in the case of flash memories. In addition, it is also known practice to achieve inherent safety on the basis of redundant components, such as memory modules (e.g. RAM, ROM, cache), CPUs, monitoring modules and bus comparators or memory protection units.

However, such architectures cannot be used to recognize “defects” or “design faults” in a piece of software.

Such defects may be translation faults—not recognized in the course of a release process for the software, for example—by a compiler or assembler which arise and become obvious only under specific constraints.

Known solutions for protecting software components from such defects are to make a different assembler/compiler or an amended assembler/compiler selection, for example speed optimized instead of memory optimized or different optimization levels.

Design faults in a piece of software involve “fallacies” from the developers, for example, and, when the software is executed under specific circumstances, result in unspecified behavior or in an incorrect mode of operation of the system, i.e. there is unsatisfactory mapping of the external circumstances or operating situations that are to be expected onto the structure of the software or modes of operation.

In order to protect software components from such design faults, it is known practice to have the function performed by a second, third, . . . n-th software component and to compare and rate each of the results with those of the (n-1) other software components.

This known fault recognition approach for recognizing design faults has the following disadvantages:

the n-th software components require an almost n-fold runtime for the calculation in a single runtime environment on a single inherently safe microprocessor module;

in the event of failure of the underlying single-redundancy hardware, all of the software is shut down; this leads to a poor result in terms of the robustness and availability of the whole embedded system,

beyond safety level ASIL-D, dual hardware faults are not guaranteed to be recognized by the hardware monitoring modules trimmed to recognize single faults and can result in unclear circumstances which, in terms of programming, do not permit design faults in the software components to be clearly distinguished from hardware defects. By way of example, dual faults in flash or RAM memories and in microprocessors are thus not recognized at the hardware level, and result in corruption of an input, of an algorithm or of an output from one or more software components with the result that the influenced software components are shut down without possibly explaining the precise cause. Downstream offline analysis would be difficult, laborious and costly,

sequential execution of the n-fold software components (serialization) has the medium-term result, on the basis of experience, of software structures which can no longer be separated in principle. Few monolithic blocks are produced which are considered, developed and tended in a restricted context. The consideration of such an overall system from the point of view of an FSM is continually more difficult and the introduction of a multilevel fallback level concept is very complex on account of the boundaries of the software components no longer being clearly defined,

finally, the manageability, care and maintenance of the software components themselves are lost on account of the monolithic structure.

In order to assess the reliability of safety functions for software and hardware components of automotive systems, ISO standard 26262 defines what are known as safety levels, ASIL (Automotive Safety Level) for short. The respective safety level is a measure of the functional safety of the system on the basis of the risk to and endangerment of persons, which may be based on the system function. Functions or processes with relatively low endangerment are, in principle, set up by a safety group to have a lower safety integrity level than processes with relatively high endangerment. On the basis of this standard, there are four safety levels ASIL-A to ASIL-D, with ASIL-D being the highest safety requirement. Software failure on the basis of design faults corresponds to the ASIL-D safety level in this case.

The invention is based on the object of specifying a microprocessor system as mentioned at the outset which ensures inherent safety on the basis of ASIL-D classification at hardware and software level and, in addition, is flexible in terms of handling and maintenance of the software components and has a multilevel fallback level concept.

This object is achieved by means of the features of the present invention.

### INTRODUCTORY DESCRIPTION OF THE INVENTION

Such a microprocessor system for executing at least partially safety-critical software modules as part of the control and/or regulation of functions or tasks which are associated with the software modules, which microprocessor system comprises at least one inherently safe microprocessor module having at least two microprocessor cores, is distinguished, according to the invention, in that:

at least one further inherently safe microprocessor module having at least two microprocessor cores is provided, wherein the at least two microprocessor modules are connected by means of a bus system,

at least two software modules which perform at least partially overlapping functions are provided,

these software modules having at least partially overlapping functions are distributed over a microprocessor module or over at least two microprocessor modules, and

means for comparing and/or arbitrating the results produced with the software modules for the identical functions are provided for the purpose of recognizing software and/or hardware faults.

Such a microprocessor system according to the invention can be used to integrate inherently safe microprocessor modules such that in the event of a fault the relevant hardware component or the software component can be clearly identified and can be shut down on a case-dependent basis.

This is ensured by the property of the inherent safety of the microprocessor modules, with the result that in the event of a hardware fault another microprocessor module is activated or left to continue and a software module performing the same or identical or similar or alike but less comprehensive function is started at that point. The aforementioned software module may also already be running in a kind of standby mode, but may still require clearance to access the ultimate control of an actuator or of the communication on a bus medium, for example, before it effectively obtains control or clearance to perform active actions. This clearance may be provided as follows, for example, namely explicitly by an arbitrator in the form of a monitoring software module, or explicitly by virtue of self-indication by the primarily responsible software module with a report that it is shutting down or has been shut down on account of a fault, or implicitly by the absence of alive signals from a microprocessor module on which the primarily responsible software module is executed. The at least partially redundant software modules mean that, in the event of a fault in one of these software modules, it is possible for the one with the related function to be executed which is allocated on the same or a different microprocessor module.

In particular, it is possible to recognize whether failure of an inherently safe microprocessor module or of a software module has occurred, with a software module being able to be recognized as faulty even if the serviceability of that microprocessor module on which this software module is located is assured at the same time.

Finally, the microprocessor system according to the invention can be used to provide a hardware/software architecture which allows software components, such as ABS or ESP functions or program modules or tasks, to be distributed over different inherently safe microprocessor modules, it also being possible, by way of example, for two mutually monitoring ESP software modules (which do not necessarily need to be programmed in identical fashion in order to comply with prescribed ASIL safety levels, or, when measured against the original functional specification, are meant or even need to satisfy the fundamentally identical development stipulations but to be implemented in a different manner) to run on one inherently safe microprocessor module in parallel if necessary.

In one advantageous embodiment of the invention, when a faulty software module is recognized, the fault is rectified by virtue of the function of said software module being allowed to be performed by a further software module which has this function at least as a function that overlaps the faulty software module or which is identical in terms of the functions or tasks to be performed, that is to say is used for the same purpose.

Hence, such a microprocessor system provides a safety architecture having increased robustness, since when one software module fails other software modules remain active. In particular, subfunctions or subtasks of the software module that fails can be started as backup routines or program segments on another software module on the same or another microprocessor module which are not identical to the software module that fails, but can also perform this subfunction or subtask.

In addition, it is particularly advantageous if, on the basis of one development of the invention, when a faulty microprocessor module is recognized, the fault is rectified by virtue of a further microprocessor module undertaking the performance of the function of the faulty microprocessor module on which the software module required for performing this function is located. This provides a safety architecture having further-increased robustness, since when one microprocessor module fails other microprocessor modules remain active, software modules continue to be executed in part or in full in the event of a fault and, in this case too, subfunctions or subtasks can be charged with control as backup routines or program segments in another software module on another microprocessor module.

In this case, on the basis of one development, it is particularly advantageous that in order to perform a safety-relevant function there are software modules provided which have essentially redundant software and which are distributed multiple times over one or more microprocessor modules.

The accordingly increased availability is expressed in the fault tolerance of the microprocessor system according to the invention in the light of failure of a software module in that an identical or partially identical software module can be executed for fault handling.

In addition, the functional safety of the microprocessor system is increased if, on the basis of one development of the invention, in order to perform a safety-relevant function there are software modules provided which have software with diversified redundancy and which are distributed multiple times over one or more microprocessor modules. This ensures both protection at hardware level by virtue of the inherent safety of the microprocessor modules and protection at software level by virtue of the redundancy of these software modules with the diversified-redundant software.

Furthermore, it is particularly advantageous if, on the basis of one embodiment of the invention, each microprocessor module has, for the purpose of performing basic functions, software basic modules, preferably communication software modules, input plausibilization software modules and task-specific software modules, which are each located on the microprocessor module once.

Hence, the microprocessor system according to the invention having a plurality of microprocessor modules can be used to execute not only safety-critical software, such as brake control software (ABS/ASR/EBV) or driving dynamics control software (ESP/ESC), but also nonsafety-critical software, for example software for navigation systems or systems which are not highly safety critical, such as cruise control systems (ACC) or other software for nonsafety-critical driver assistance systems or added-convenience functions in parallel with the safety-critical software. Since the microprocessor modules are designed to have an inherently safe multiprocessor structure, this can be implemented in various runtime environments (RTEs) on account of the robustness and as far as possible minor interactions.

Preferably, the microprocessor modules can be implemented as an ASIC, providing the assurance that the various microprocessor modules do not just have their IC packages connected over a physically short distance, which continues to be necessary for introduction into bus systems suitable for printed circuit boards or wiring harnesses, which bus systems are fast but not fastest, but also are able to be used at the level of the DIE or structures or buses that are common to the silicon for the best possible data transmission speed, with the result that short distances cater for fast data transmission, fast bus systems can be provided and only short latencies arise.

A further advantage is that software modules of different origin (for example OEM-specific applications and proprietary developments) can be decoupled on the microprocessor system, since it is possible both for the one software module to be located on one inherently safe microprocessor module and for the other software module to be located on another inherently safe microprocessor module. In particular, this also allows safety-relevant software to be decoupled from non-safety-relevant software.

Preferably, on the basis of one development, the software basic module provided is an output arbitration software module which performs arbitration and advantageously also a plausibility check on the results from the redundant and/or diversified-redundant software modules performing a safety-relevant function. This allows clear fault association, that is to say whether a microprocessor module has failed or a software module has failed. The reason is that, in conjunction with the inherently safe microprocessor modules, the software modules can be detected as being faulty in the event of a negative comparison of the results from redundant software modules while the serviceability of the microprocessor modules is simultaneously assured. The advantage is thus that not only is it possible to spot hardware faults, it is also possible to spot design-oriented software faults through the parallel execution of software.

It is particularly advantageous, on the basis of one development of the invention, if the microprocessor cores of at least one microprocessor module as a multiprocessor platform operate in a lockstep mode (LSM), which achieves protection largely on the basis of physical redundancy, that is to say duplicated structures. Such a microprocessor module operates in this LSM mode, in principle, but it can also be put into this LSM mode after the supply voltage is switched on following an initialization routine or after an external reset signal or at runtime as a one-off process, and this microprocessor module also remains in this LSM mode.

Furthermore, on the basis of one development, the microprocessor cores of at least one microprocessor module as a multiprocessor platform can operate in a decoupled parallel mode (DPM), that is to say that the microprocessor module achieves its functional safety aims by means of the architectonic measure of asymmetric redundancy. This achieves the protection by virtue of integral matching with respect to time which is based on asymmetrical physical redundancy of the components.

On the basis of one embodiment of the invention, the microprocessor system according to the invention may have not only a plurality of microprocessor modules as multicore processor platforms but also at least one microprocessor module having a single microprocessor core (single core processor). Preferably, these microprocessor modules are connected to at least one bus system having an input/output interface in order to allow external expandability.

In addition, on the basis of one development of the invention, the microprocessor system according to the invention can be designed to have microprocessor modules which each have operating systems of the same type. Hence, it is preferably possible for this to involve the use of an operating system which distributes the computation load over the various microprocessor modules statically, semi-dynamically or fully dynamically.

In one embodiment of the invention, some of the microprocessor modules are each equipped with a time-slice-based operating system, which are synchronized. This means that the microprocessor modules are coupled to one another in phase-locked fashion. This can be achieved, by way of example, by virtue of time stamps being sent at equidistant times by a transmitter using external or onchip bus systems in combination with advantageous alignment of the time slice on the part of the receiver.

Finally, the invention provides for the microprocessor modules to be at least to some extent designed as an ASIC having a common package.

The microprocessor system according to the invention is advantageously suitable for use in an electronic vehicle controller which is preferably provided for brake control and regulation, but on the basis of properties is typically also predestined to accommodate software modules which coordinate the driving dynamics behavior of the, or of a selected group of, chassis controllers. In this case, the coordination may comprise actions for the purpose of system-wide changes of mode of operation for the operating points of the controllers in the chassis domain or else single-stage or multi-stage or cascaded or embedded control loops.

### BRIEF DESCRIPTION OF THE DRAWINGS

The invention is described in more detail below using exemplary embodiments with reference to the appended figures, in which:

FIG. 1 shows a schematic block diagram of a microprocessor system with inherently safe microprocessor modules as basic elements according to the invention,

FIG. 2 shows a schematic block diagram of an inherently safe microprocessor module of the microprocessor system shown in FIG. 1,

FIG. 3 shows a schematic block diagram of a further inherently safe microprocessor module of the microprocessor system shown in FIG. 1, and

FIG. 4 shows a schematic illustration of a split for various software modules over two microprocessor modules of a microprocessor system as shown in FIG. 1.

### DETAILED DESCRIPTION

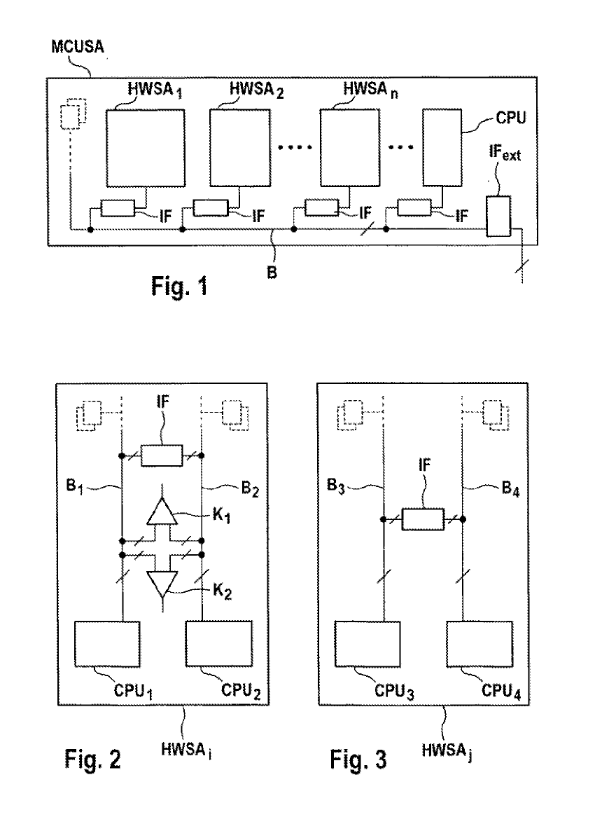

A microprocessor system MCUSA as shown in FIG. 1 comprises a plurality of duplicated basic elements which, as inherently safe microprocessor modules HWSAᵢ (i=1, . . . i=n), also called CPU modules, have at least two microprocessor cores CPU₁ and CPU₂ or CPU₃ and CPU₄, as can be seen from FIGS. 2 and 3. In addition, this microprocessor system MCUSA may comprise at least one microprocessor CPU which, as a standard microprocessor (that is to say is not inherently safe), has just one core (single core processor). Each of these microprocessor modules HWSAᵢ (i=1, . . . i=n) and the standard microprocessor CPU are connected to a central bus system or network B via an interface IF, with an interface IFₑₓₜ being able to be used for expansion for the connection of further components, for example hardware modules. It is also possible for the microprocessor modules HWSAᵢ (i=1, . . . i=n) and possibly also the standard microprocessor CPU to be fully or partially networked to one another by means of a plurality of, possibly autarkic, bus systems.

The inherently safe microprocessor module HWSAᵢ as a dual core microprocessor as shown in FIG. 2 operates in what is known as LSM (lockstep) mode, i.e. such microprocessors execute the same program segment redundantly and in clock sync (hence lockstep mode), the results from the two microprocessor cores CPU₁ and CPU₂ are compared and a fault is then detected during the comparison for a match.

Each microprocessor core CPU₁ and CPU₂ of the microprocessor module HWSAᵢ shown in FIG. 2 has a dedicated bus system B₁ or B₂ which are connected by means of an interface IF. In order to perform the comparison of the results, redundant comparators K₁ and K₂ are advantageously provided which, for the purpose of detecting single faults from hardware defects, monitor all the inputs and outputs of the redundant basic elements of this microprocessor module HWSAᵢ, and also the two microprocessor cores CPU₁ and CPU₂ shown by way of example in FIG. 2 in the case of a fault, that is to say prompts shutdown of this microprocessor module HWSAᵢ or degradation thereof in the event of a discrepancy between the two microprocessor cores CPU₁ and CPU₂. The protection is achieved through extensive symmetric physical redundancy, i.e. structures are duplicated. Besides the microprocessor cores CPU₁ and CPU₂ shown, this microprocessor module HWSAᵢ comprises further components, such as main memory (RAM), program memory (flash or ROM), comparator and safety modules, modules for external buses (CAN, LIN, Flexray, MOST, ISOK, Ethernet), such components also being able to be of redundant design for safety reasons. It is also possible for such components to have a symmetric redundancy besides the physical redundancy for the purpose of essential duplication of the structures and besides the case of simple execution entirely without full duplication. By way of example, it should be mentioned that a flash or ROM memory can be expanded by additional memory capacities which are used for the purpose of accommodating checksums. These additional elements in the sense of memory bits for nonfunctional but rather safety-oriented purposes is formally comparable with a partially redundant embodiment which, whether on the basis of its incompleteness cannot operate on the basis of the principle of physical redundancy, the aforementioned lockstep mode LSM, but rather needs to operate, integrally with respect to time, on the basis of the principles of asymmetrically protective structures.

The inherently safe microprocessor module HWSAⱼ as a dual core microprocessor having two microprocessor cores CPU₃ and CPU₄ as shown in FIG. 3 operates in what is known as DPM (decoupled parallel) mode, i.e. it can execute different program sequences independently of one another. Each microprocessor core CPU₃ and CPU₄ has a dedicated bus B₃ or B₄, which are connected by means of an interface IF. Besides these two cores CPU₃ and CPU₄, further components, such as main memory (RAM), program memory (flash or ROM), comparator and safety modules, modules for external buses (CAN, LIN, Flexray, MOST, ISOK, Ethernet), are also present. Protection is achieved by means of integral matching with respect to time and may be based both on symmetric and on asymmetric physical redundancy of the components.

The microprocessor system MCUSA shown in FIG. 1 therefore comprises a parallel structure consisting of a plurality of inherently safe basic elements, namely the microprocessor modules HWSAᵢ (i=1, . . . i=n), and is a microprocessor safety architecture, this structure being able to be produced as an ASIC or at least with a few ASICs in a single package.

This microprocessor system MCUSA shown in FIG. 1 is not just a hardware system architecture which ensures inherent safety based on ASL-D classification but also ensures inherent safety based on this safety level ASIL-D at the software level, as will be explained below.

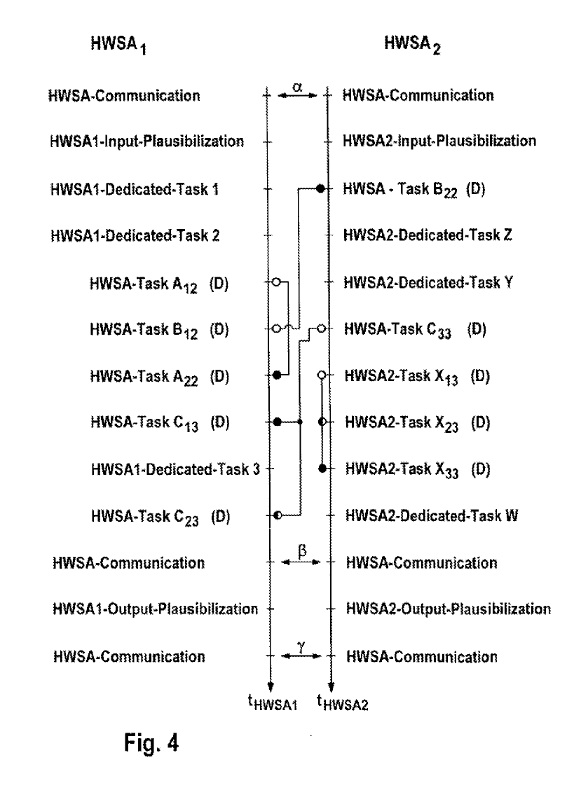

In this regard, FIG. 4 shows an example of the static allocation or distribution of various software modules over two inherently safe microprocessor modules HWSA₁ and HWSA₂ of a microprocessor system MCUSA, as shown in FIG. 1, for example. In this case, these two microprocessor modules HWSA₁ and HWSA₂ may be designed as shown in FIG. 2 or FIG. 3. The software modules shown in the respective microprocessor module HWSA₁ and HWSA₂ are sequentially executed in line with the time axes or time bases t_{HWSA1} and t_{HWSA2} of a, by way of example, associated runtime environment, beginning and ending with an “HWSA Communication” software basic module in each case. In this case, those software modules which correspond to safety level ASIL-D, that is to say software having a high safety level, for example for safety-critical applications, such as ABS or ESP functions, as arise in specific embodiments, are denoted by (D).

For the software modules on the two microprocessor modules HWSA₁ and HWSA₂, a distinction is drawn between, on the one hand, what are known as software basic modules, which are provided on each of the two microprocessor modules HWSA₁ and HWSA₂ and are each executed only once, and, on the other hand, software modules, which are allocated and executed with multiple redundancy statically on one microprocessor module, that is to say HWSA₁ or HWSA₂, for example, or a plurality of microprocessor modules, that is to say HWSA₁ and HWSA₂, for example. In this case, some of the software modules may even have overlapping tasks.

These software basic modules are communication software modules, input plausibilization software modules and task-specific software modules.

The aforementioned “HWSA Communication” software basic module allows data to be interchanged, either unidirectionally or bidirectionally via a bus system or a network B for the microprocessor system MCUSA (cf. FIG. 1). This is meant to include input variables for the control functions, runtime-relevant data (counters, status information, system times, etc.) and output variables/results from the control functions.

The input plausibilization software modules “HWSA1 Input Plausibilization” and “HWSA2 Input Plausibilization” are used for plausibilizing the input variables obtained beforehand by communication, that is to say by means of the “HWSA Communication” software basic modules, in order to be able to be forwarded as qualified values to the control functions, since only results from control functions which may involve qualified input variables can also be compared meaningfully following completion of the calculation.

In addition to the check of communication data which is performed in the input plausibilization software modules, it is also possible to use what is known as end-to-end protection, also called E2E, which, on the basis of the operating principle, adds a clear protection checksum to the data item as early as in the control function producing the communication data item and sends said checksum with the data item as an atomic unit simultaneously and together. This protection checksum is used by the control function receiving the data item or all control functions receiving the data item on the basis of known calculation keys for the E2E checksum in order to cross-check for correct transmission of the data item, and therefore even means provided for detecting a corruption that has occurred on account of a design fault in the output plausibilization software module on the part of the transmitter and in the input plausibilization software module on the part of the receiver and being able to react thereto accordingly.

The task-specific (dedicated task) software basic modules of the microprocessor module HWSA₁ and the microprocessor module HWSA₂ are denoted as “HWSA1 Dedicated Task 1”, “HWSA1 Dedicated Task 2” and “HWSA1 Dedicated Task 3” or “HWSA2 Dedicated Task Y”, “HWSA2 Dedicated Task Z” and “HWSA2 Dedicated Task W”, as shown in FIG. 4. These software basic modules are also executed in a simple manner, without having to meet further requirements placed on diversity and increased robustness or without redundancy. These task-specific software basic modules exist essentially only once and are executed on the microprocessor module HWSA₁ or HWSA₂ “in dedicated fashion”.

In addition, the software modules provided are also output arbitration software modules, denoted as “HWSA1 Output Plausibilization” and “HWSA2 Output Plausibilization”, which are used for plausibilizing the output values or manipulated variables determined beforehand by the full complement of all control functions. In this case, a distinction is drawn between the functionally necessary plausibilization and the plausibilization which is necessary for functional safety. These different plausibilizations are described further below.

In addition, there are software modules which are located on one microprocessor module multiple times and/or on a plurality of microprocessor modules in distributed form and are denoted by “HWSA Task Aᵢⱼ”, “HWSA Task Bᵢⱼ”, “HWSA Task Cᵢⱼ” and “HWSA Task Xᵢⱼ” as shown in FIG. 4. These redundant software modules have the same task, i.e. are used largely for the same purpose.

The result for the microprocessor system MCUSA is therefore increased availability and increased safety as a whole.

When such software modules are distributed over a plurality of microprocessor modules HWSAᵢ, higher robustness demand and higher availability in the face of hardware failures are met.

In the case of static allocation of such software modules both on a multiple basis within one microprocessor module HWSA₁ or HWSA₂ and on a plurality of microprocessor modules HWSA₁ and HWSA₂, increased safety requirements in the face of “defects” or else “design faults” are met.

Thus, the two software modules “HWSA2 Task X₁₃” and “HWSA2 Tasks X₂₃” allocated on the microprocessor module HWSA₂ are of redundant design with essentially the same algorithm, both software modules being programmed by the same programmer A, but the software module “HWSA2 Task X₂₃” being compiled or assembled differently than the software module “HWSA Task X₁₃”, which results in essentially one identity at the program code level, but the different translation means that systematic faults can be precluded.

Furthermore, the two redundant software modules “HWSA Task C₃₃” and “HWSA Task C₂₃” are distributed over the two microprocessor modules HWSA₁ and HWSA₂, both software modules likewise having been programmed by the same programmer A, but the software module “HWSA Task C₂₃” being compiled or assembled differently than the software module “HWSA Task C₃₃”, which results in essentially one identity at the program code level, but the different translation means that systematic faults can be precluded.

These redundant software modules “HWSA Task X₁₃” and “HWSA Task X₂₃” or “HWSA Task C₃₃” and “HWSA Task C₂₃” thus have an identical or just marginally modified algorithm.

Finally, software modules with diversified redundancy are provided which are distributed over the same microprocessor module HWSA₁ or HWSA₂.

As FIG. 4 shows, these are the two software modules “HWSA Task A₁₂” and “HWSA Task A₂₂” allocated on the microprocessor module HWSA₁, which are programmed by two different programmers A and B. The two redundant software modules “HWSA2 Task X₁₃” and “HWSA2 Task X₂₃” on the microprocessor module HWSA₂ also have a software module “HWSA Task X₃₃” with diversified redundancy in existence on the same microprocessor module HWSA₂. Such software modules vary to a very great extent in terms of structure.

Such software modules with diversified redundancy can also be distributed over different microprocessor modules. Thus, FIG. 4 shows a software module “HWSA Task B₁₂” which is allocated on the microprocessor module HWSA₁ and which has been programmed by a programmer A, and a software module “HWSA Task B₂₂” which is allocated on the microprocessor module HWSA2, which has diversified redundancy and which has been programmed by another programmer B. The two redundant software modules “HWSA Task C₂₃” and “HWSA Task C₃₃”, which are distributed over both microprocessor modules HWSA₁ and HWSA₂ and which have been programmed by a programmer A, also have a software module “HWSA Task C₁₃” in existence on the microprocessor module HWSA₁, said software module having diversified redundancy and having been programmed by another programmer B. Such software modules vary to a very great extent in terms of structure.

The number m of software modules having diversified redundancy may be greater than the number n (n<m) of the microprocessor modules HWSA, (i=1, . . . n). In such a case, it is possible for serialization of n software modules to be performed on a single microprocessor module HWSAᵢ. It goes without saying that in this case there may be a prerequisite for adequate computation power for the underlying microprocessor module, and increased safety can be achieved by the sequentially calculated and ultimately plausibilized—in terms of their output signals—software modules. However, availability in the face of failure of the underlying microprocessor module is not increased in this case of all the software modules being introduced, and it does not matter whether these software modules are programmed redundantly or translated differently. The availability is increased when the redundant software modules are incorporated in different microprocessor modules in a diversified manner.

Such software modules “HWSA Task Aᵢⱼ”, “HWSA Task Bᵢⱼ”, “HWSA Task Cᵢⱼ” and “HWSA2 Task Xᵢⱼ” with diversified redundancy, which serve the same purpose and which have a totally different algorithm as intended, provide the basis for output variables or results from control functions to be calculated in a manner which is redundant by design, ensuring protection in the face of design faults.

The relatively high availability is manifested in tolerance by the microprocessor system MCUSA in the face of failure of a microprocessor module HWSAᵢ, since in such a case in which a fault is detected or one microprocessor module HWSAᵢ fails, it is possible for another microprocessor module HWSAⱼ (i□j) to execute an appropriate software module.

Increased functional safety is achieved by the software modules with diversified redundancy which are executed on different microprocessor modules HWSAᵢ, which ensures both protection at hardware level as a result of the inherent safety of the microprocessor modules HWSAᵢ and protection at software level as a result of the diversified redundancy of the software modules, that is to say as a result of the algorithm thereof not being the same.

Back to the software modules “HWSA1 Output Plausibilization” and “HWSA2 Output Plausibilization” on the microprocessor module HWSA₁ or HWSA₂ shown in FIG. 4.

In the case of the functionally necessary plausibilization by means of the software modules “HWSA1 Output Plausibilization” and “HWSA2 Output Plausibilization”, specific software modules performing control functions are prioritized and others are deferred. By way of example, in connection with an ESP control function and an ABS control function, the control function of an ESP intervention is thus superior to that of an ABS intervention and is therefore performed with priority and first. Such functional plausibilization is performed to the benefit of the handling of the vehicle.

The plausibilization using the software modules “HWSA1 Output Plausibilization” and “HWSA2 Output Plausibilization”, which is necessary from the point of view of functional safety, involves the results from the software modules which are executed redundantly or quasi-redundantly and, depending on the static allocation, are distributed over different microprocessor modules HWSAᵢ being compared or rated with one another. Thus, the results from two independent ESP control functions (that is to say serving the same purpose, namely providing the vehicle with an “ESP” function) would be compared with one another. In the example shown in FIG. 4, the software module “HWSA Task Bᵢⱼ”, for example, is implemented twice, namely as “HWSA Task B₁₂” on the microprocessor module HWSA₁ and as “HWSA Task B₂₂” on the microprocessor module HWSA₂. The consistency of the relevant input data for this software module is ensured by the previously executed software module “HWSA Communication” at the time α (cf. FIG. 4). The presence of the calculated output data for comparison or weighting on both sides is ensured by the software module “HWSA Communication” at the time β. The presence of the achieved comparison results or weighting results on both microprocessor modules HWSA₁ and HWSA₂ is ensured by the software module “HWSA Communication” at the time γ.

Furthermore, the microprocessor system MCUSA shown in FIG. 1 is designed for dynamic processing in respect of the software modules.

If the software module “HWSA1 Dedicated Task 3” fails, for example, and a subfunction or subtask therefore cannot be performed and this subtask or subfunction is also present as a program segment on the software module “HWSA2 Dedicated Task Z” of the microprocessor module HWSA₂, this “HWSA2 Dedicated Task Z” software module is activated as a backup software module according to its role and its backup routines are performed.

Dynamic processing means that, depending on state, that is to say in respect of hardware or software or modes of operation of the microprocessor system, particular microprocessor modules HWSAᵢ or particular software modules, that is to say on the basis of need, are executed. A prerequisite for this is naturally the static allocation of appropriate software modules, as has been described in connection with FIG. 4.

The set of distributed or diversified software modules essentially includes two types:

a) such software modules as are used for increased functional safety, that is to say that a continual result comparison is performed in the microprocessor modules HWSAᵢ, and

b) such software modules as are used for increased availability and can ideally be executed alternatively or started dynamically in order to save resources and execution time in the normal mode of operation, if this is advantageous.

Software modules having diversified redundancy are introduced, as described above, to the benefit of protecting the software or the algorithms in the face of “design faults”.

These software modules with diversified redundancy do not necessarily have to be accommodated on different microprocessor modules HWSAᵢ. These software modules fall into category a cited above. These software modules with diversified redundancy are also developed redundantly from an alternative point of view, are designed by a different team and are implemented by a different programmer. The probability of a specific “design fault” being repeated is decreased as a result.

By way of example, design faults can arise as a result of the embodiment of included state machines, state transitions upon a change from one mode of operation to the other, fault reaction procedures or the like. Particularly within program segments in which the programmer(s) map(s) mutually dependent different instantaneous measured or controlled variables or actual states and also manipulated or control values or target states, that is to say in respect of combinatorial analysis or in a certain order, that is to say in respect of sequence, onto an algorithm and how the latter is meant to work, execute alternative equations or jump to different safety levels, for example, an immensely complex and complicated tree of permutations arises from the consideration of a multilevel sequence to be performed using multichannel combinatorial analysis. These circumstances are favorable to design faults creeping in on supposedly small, isolated or possibly—upon occurrence—fatal program sections which, on account of their not very expansive nature, are difficult to identify fully in advance using development tests and/or continuous runs.

To the benefit of the robustness of the microprocessor system MCUSA in the face of hardware failures, it is possible for software modules, as described above, to be distributed or diversified over various microprocessor modules HWSAᵢ. These software modules fall into category b) cited above. For safety reasons, permanent and concurrent execution, including mutual comparison of the results from these software modules, is therefore not required. Robustness would also not increase as a result. By contrast, need-based execution of the diversified software modules would mean more efficient use of the runtime reserves of the microprocessor modules HWSAᵢ. The need can arise through entry into a specific operating situation. This special operating situation may be a detected fault in a microprocessor module HWSAᵢ, and this may also be a special self-calibration of diagnosis procedure which temporarily restricts serviceability, or may be a continually present undervoltage situation. It is not necessary to have the full functionality covered by backup software modules. The backup software modules can turn out to be more slimline and may be smaller in terms of code size and runtime consumption. For reasons of efficiency, the microprocessor module HWSAᵢ that dynamically executes the backup software modules can dynamically shut down a set of its local, non-essential software modules in order to be able to ensure that the backup software modules are processed.

In addition, the microprocessor system MCUSA shown in FIG. 1 provides plausibilization continuously over time, that is to say continual comparison of the results from the distributed software modules.

For the purpose of assessing the relevant input data, results and partial results and also output data from the software modules which are present on the respective microprocessor module HWSAᵢ and are calculated in distributed fashion, which data and results are required for functional safety, they are communicated in a suitable manner at different times (α, β and γ as shown in FIG. 4) within the microprocessor system MCUSA, as has been explained in connection with FIG. 4 for the times α, β and γ explained above. Hence, a means is provided which allows both the serviceability of the distributed redundant microprocessor modules HWSAᵢ within the microprocessor system MCUSA to be communicated and the serviceability of the distributed software modules in respect of the exclusion of program weaknesses which have occurred as a result of design faults in the algorithm to be proved at runtime.

In summary, the microprocessor system MCUSA according to the invention is distinguished by the following advantages:

It exhibits increased robustness for the embedded overall system both in respect of hardware and in respect of software:
if one microprocessor module fails, other microprocessor modules remain active; software modules continue to be executed in part or in full. In addition, backup routines in another software module on another microprocessor module are charged with control,
if one software module fails, other software modules remain active. It is possible for the same software module to be restarted or reinitialized on the basis of the redundancy. In addition, backup routines in another software module on the same or another microprocessor module HWSAᵢ can be started.

Opportunity for Clear Fault Association with Hardware or Software in the Case of a Fault:
if one microprocessor module HWSAᵢ fails, this is clearly indicated, for example by a register, an interrupt, an exception or a piece of monitoring hardware which automatically sets a signal or pin;
if one software module fails, this is established clearly by means of comparison or rating with the results for another software module; and
recognition of a cause upon interpretation of whether a microprocessor module HWSAᵢ or a software module has failed is possible clearly, since inherently safe microprocessor modules HWSAᵢ having infrastructure modules of a correspondingly inherently safe design (RAM, FLASH, buses, etc.) are used, which means that in the event of a negative result comparison, i.e. results from redundant software modules have been inconsistent, the software modules can be classified as unserviceable while the serviceability of the microprocessor modules HWSAᵢ is simultaneously assured. Optionally, it is possible to use two-fold or multiple redundancy of the software modules in order to clearly identify the problematic software module by virtue of majority formation and nevertheless to maintain safe function execution.

Dynamic Computation Capacity Allocation:
if one microprocessor module HWSAᵢ fails, backup routines in another software module on another microprocessor module HWSAⱼ are charged with control; and
if one software module fails, backup routines in another software module on the same or another microprocessor module HWSAᵢ are started.

Flexible design of the embedded overall system comprising microprocessor module HWSAᵢ and software modules:
structured nature and ease of portability of the software modules beyond the microprocessor modules HWSAᵢ can be achieved implicitly “by design”.

The microprocessor system MCUSA can be designed as an ASIC in a single package. Naturally, it is also possible for the microprocessor system MCUSA to be implemented on two or more ASICs and then to be combined in a single IC package or for each ASIC to be packaged into a separate IC package.

In addition, it is possible for the operating systems of the microprocessor module HWSAᵢ to be able to be the same or of a different nature, and also for a single operating system to be able to be used which distributes the computation load over the various microprocessor modules HWSAᵢ statically, semi-dynamically or fully dynamically.

Finally, those operating systems of the microprocessor modules HWSAᵢ which operate on a time-slice basis can be designed to be able to be synchronized with one another, i.e. can adopt a defined phase-locked state relative to one another, which can be achieved by the sending of timestamps by a transmitter at equidistant times using external or onchip bus systems in combination with advantageous alignment of the time slice (loop) on the part of the receiver.

While the above description constitutes the preferred embodiment of the present invention, it will be appreciated that the invention is susceptible to modification, variation and change without departing from the proper scope and fair meaning of the accompanying claims.

1. A microprocessor system for executing at least partially safety-critical software modules as part of the control or regulation of functions or tasks which are associated with the software modules, which microprocessor system comprises, at least one first inherently safe microprocessor module (HWSAᵢ) having at least two microprocessor cores (CPUᵢ),
at least one second inherently safe microprocessor module (HWSAᵢ, i=1, n) having at least two microprocessor cores (CPU₁, CPU₂; CPU₃, CPU₄), wherein the first and second microprocessor modules (HWSA₁, HWSA₂) are connected by means of a bus system (B),
the software modules including a first and a second software module
having at least partially overlapping functions including identical functions and are distributed over one or more of the first and the second microprocessor modules (HWSA₁, HWSA₂), and
means for comparing or arbitrating the results produced with the first and second software modules for the identical functions for the purpose of recognizing a software fault or a hardware fault.

2. The microprocessor system (MCUSA) as claimed in claim 1, further comprising in that when the software fault is recognized, the software fault is rectified by virtue of the identical function of one of the software modules being performed by another of the software modules which has the identical function.

3. The microprocessor system (MCUSA) as claimed in claim 1, further comprising in that when the hardware fault is recognized of one of the first and the second microprocessor modules, the hardware fault is rectified by virtue of another of the first and the second microprocessor modules (HWSA₁, HWSA₂) undertaking the performance of the function of the microprocessor module having the hardware fault (HWSA₁, HWSA₂) on which the software module required for performing the function is located.

4. The microprocessory system (MCUSA) as claimed in claim 1 further comprising in that in order to perform the overlapping function which is a safety-relevant function the software modules are provided which have redundant software for performing the identical functions and which are distributed multiple times over one or more of the first and the second microprocessor modules (HWSA₁, HWSA₂).

5. The microprocessor system (MCUSA) as claimed in claim 1 further comprising in that in order to perform the overlapping function which is a safety-relevant function the software modules provided which have software with diversified redundancy and which are distributed multiple times over one or more of the first and second microprocessor modules (HWSA₁, HWSA₂).

6. The microprocessor system (MCUSA) as claimed in claim 1 further comprising in that each of the first and second microprocessor modules (HWSA₁, HWSA₂) have, for the purpose of performing the functions which are perform of one or more of, basic functions, software basic modules, communication software modules, input plausibilization software modules, and task-specific software modules, located on one of the microprocessor modules.

7. The microprocessor system (MCUSA) as claimed in claim 6, further comprising in that the software basic module is provided an output arbitration software module which performs arbitration and also a plausibility check on the results from one or more of the software modules performing a safety-relevant function.

8. The microprocessor system (MCUSA) as claimed in claim 1 further comprising in that the microprocessor cores (CPU₁, CPU₂) of at least one of the first and second microprocessor modules (HWSA₁) operate in a lockstepped mode (LSM).

9. The microprocessor system (MCUSA) as claimed in claim 1 further comprising in that the microprocessor cores (CPU₃, CPU₃) of at least one of the first and second microprocessor modules operate in a decoupled parallel mode (DPM).

10. The microprocessor system (MCUSA) as claimed in claim 1 further comprising in that the microprocessor system (MCUSA) contains at least one of the microprocessor cores in the form of a single core processor.

11. The microprocessor system (MCUSA) as claimed in claim 1 further comprising in that at least one of the microprocessor modules (HWSAᵢ, i=1, . . . n) have an input/output interface for external expandability.

12. The microprocessor system (MCUSA) as claimed in claim 1 further comprising in that the first and second microprocessor modules (HWSAᵢ, i=1, . . . n) have identical operating systems.

13. The microprocessor system (MCUSA) as claimed in claim 12, further comprising in that the operating system is designed to be able to distribute the computation load for performing the function over a plurality of the microprocessor modules (HWSAᵢ, i=1, . . . n).

14. The microprocessor system (MCUSA) as claimed in claim 1 further comprising in that at least one of the microprocessor modules (HWSAᵢ, i=1, . . . n) is equipped with time-slice-based operating systems, which are synchronized.

15. The microprocessor system (MCUSA) as claimed in claim 1 further comprising in that the first and second microprocessor modules (HWSAᵢ, i=1, . . . n) are at least to some extent designed as an ASIC with a common package.

16. The microprocessor system (MCUSA) as claimed in claim 1 incorporated in an electronic vehicle controller which is provided for vehicle brake control and regulation.
